(19) United States
(12) Patent Application Publication
(10) Pub. No.: US 2023/0303302 A1
(43) Pub. Date: Sep. 28, 2023

(54) POLYLACTIC ACID-BASED CUSTOM PRODUCT PACKAGING AND ASSOCIATED METHODS

(71) Applicant: Lifoam Industries, LLC, Greer, SC (US)

(72) Inventors: Saumitra Bhargava, Clarksville, MD (US); Jonathan Godfrey, Joppa, MD (US); Timothy Pritchett, Inman, SC (US)

(21) Appl. No.: 18/191,422

(22) Filed: Mar. 28, 2023

Related U.S. Application Data
(60) Provisional application No. 63/362,004, filed on Mar. 28, 2022.

(51) Int. Cl. B65D 81/02; C08J 9/16; C08J 5/12; B29C 44/56

(52) U.S. Cl. CPC B65D 81/022; C08J 9/16; C08J 5/128; C08J 5/121; B29C 44/5627; C08J 2367/04; B29C 44/445

(57) ABSTRACT

Molded foam articles are provided. The molded foam articles are formed from polylactic acid and are capable of a number of post-processing or secondary uses. Forming the molded foam articles from polylactic acid advantageously extend the life of the molded bead foam article by permitting users to cut, heat, adhere, modify, and repurpose the molded foam articles.

### CROSS-REFERENCE TO RELATED APPLICATION

This application claim priority to U.S. Provisional Patent Application No. 63/362,004, filed Mar. 28, 2022, which is incorporated herein by reference.

### FIELD OF THE DISCLOSURE

This disclosure relates generally to molded foam articles and, in particular, relates to custom product packaging composed of low-density molded foam articles formed from polylactic acid and further modified as needed through thermoforming, self-adhesion, water-treatment, and guide formation.

### BACKGROUND

Molded foam articles are used in a variety of diverse industries including thermal insulation and protective packaging, construction, infrastructure support, foodservice, and consumer products. Molded foam articles are commonly produced from expandable polystyrene (EPS), which has a well-known manufacturing process. However, EPS-based foam articles suffer from a variety of drawbacks that prevent not only recycling the EPS article, but also repurposing the EPS article for secondary uses.

Consumer-facing foam articles such as insulated shippers are commonly used for shipping meal kits, confectionary products, cakes, other perishable goods, and pharmaceutical items such as vaccines. These insulated shippers are normally discarded by the end-user after their initial purpose has been served, and discarded EPS products contribute over 1,300 tons of waste to landfills in the United States every day.

Prior attempts to reduce molded bead foam article waste have included a shift towards biobased and compostable foam materials as alternatives to EPS. For example, polylactic acid (PLA) can be used to produce molded foam articles having insulative and protective properties equal to or superior to those of EPS, but with the added benefit of being compostable. However, molded foam articles rarely have utility in any secondary use beyond the initial application for which the molded bead foam article was made.

Creating production lines and equipment to produce protective packaging for a unique or a small number of products is wasteful. Protective kits made with polyurethane (PU) with partially cut pieces are available to increase customization of the protective packaging. By cutting or pulling apart the partially cut pieces, the foam can be adapted to the product being shipped. While this may reduce the costs of producing the protective packaging by homogenizing the manufacturing requirements of the kit, the kit creates waste polyurethane foam because of the need to cut or remove pieces to fit the application. Furthermore, the packaging remains ill-defined for the specific product being shipped. One-of-a-kind articles such as musical instruments also need easily customizable protective packaging having a high modulus (compared to flexible PU foam).

Accordingly, improved product packaging is needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is two joined PLA bead foam articles in accordance with an embodiment of the disclosure.

FIG. 2 is two joined PLA bead foam articles in accordance with an embodiment of the disclosure.

FIG. 3A is a PLA bead foam article in accordance with an embodiment of the disclosure.

FIG. 3B is the PLA bead foam article of FIG. 3A with additional PLA bead foam articles in accordance with an embodiment of the disclosure.

FIG. 4 is two joined PLA bead foam articles in accordance with an embodiment of the disclosure.

FIG. 5A is a PLA bead foam article in accordance with an embodiment of the disclosure.

FIG. 5B is the PLA bead foam article in FIG. 5A after cooling in accordance with an embodiment of the disclosure.

FIG. 6 is a PLA bead foam article in accordance with an embodiment of the disclosure.

### DETAILED DESCRIPTION

Custom product packaging is provided herein including custom product packaging composed of one or more molded bead foam articles that have been modified through at least one of (i) machining, (ii) adhesion to another molded bead foam article, (iii) boiling, or (iv) thermoforming. In particular, it has been unexpectedly discovered that forming the one or more molded bead foam articles from polylactic acid enables the molded bead foam article to be machined, adhered, enhanced through boiling, and/or thermoformed in ways superior to or, in some cases, impossible in a comparable EPS molded foam article.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

Custom Product Packaging

Custom product packaging is disclosed herein. In some embodiments, the custom product packaging includes at least one molded bead foam article comprising polylactic acid (PLA). As used herein, a “molded bead foam article” refers to an article formed from a polymeric bead foam that has gone through an expansion and bead molding process. The article may be in the form of a two-dimensional panel or a three-dimensional structure such as a box.

Other polymeric foams are capable of being expanded and molded in a way similar to expandable polystyrene, such as polypropylene, polyethylene, and polylactic acid. In some embodiments, the at least one molded bead foam article has been modified through at least one of (i) machining, (ii) adhesion to another molded bead foam article, (iii) boiling, or (iv) thermoforming.

In some embodiments, the PLA-based molded bead foam article has a low density, such as between 0.015-0.04 g/cm³. Conventional molded bead foams gain some pliability when heated, but only when the density is greater than 0.10 g/cm³, such as around 0.14 g/cm³. It has been unexpectedly discovered that PLA-based molded bead foam articles having densities as low as 0.015-0.04 g/cm³ may be thermoformed.

In some embodiments, the at least one molded bead foam article is at least partially machined. It has been unexpectedly discovered that machining a molded bead foam article formed from PLA produces up to 50% less waste than a comparable molded bead foam article formed from expandable polystyrene, and the dust that is produced is easily compostable and biodegradable. As used herein, “machined” refers to the process of cutting, drilling, milling, die-cutting and/or shaving the molded bead foam article in order to produce smaller molded foam article(s) or to shape the molded foam article. Machining processes may involve the use of lathes, cutting tools, hot wire, hot knives, rotary tools, die-cutting punches, drilling etc. When lathe, CNC, or water-jet machining EPS-based articles, micro and macroparticles of EPS are generated in the form of dust. This dust is not only undesirable as a messy byproduct of the machining process, but EPS-based foam dust remains incapable of recycling or composting. In addition, when machining PLA-based articles in a typical milling process using a fine cutting tool rotating at 30,000 rpm, there is a 40-60% reduction in fine particles that are produced compared to EPS-based molded articles under the same machining conditions.

In some embodiments, the at least one molded bead foam article that forms the custom product packaging includes predefined guides for guiding the machining process. These guides may include grooves, ridges, indentations, regions of manufactured weakness, and the like that present a visual and/or tactile indication to a user that the molded bead foam article may be machined at that point, or present a mechanical weak point for aiding the machining of the molded foam article. In some embodiments, the predefined guides are a predetermined and regular distance apart so that the user can determine, without the need for external measuring tools, the size and shape of a smaller, machined article that is produced from machining the molded foam article. In some embodiments, the predefined guides are strategically positioned so that a specific, secondary foam article is produced or may be constructed after machining the molded foam article. In some embodiments, the predefined guides are configured to indicate to a user where the user may adhere additional molded bead foam articles so as to construct a particular shape. In this way, the molded bead foam article may be machined into one or more smaller articles having sizes defined by the predefined guides and these smaller articles may be subsequently combined or incorporated into the custom product packaging.

In some embodiments, the custom product packaging includes at least two molded bead foam articles that are adhered together using an adhesive. Any suitable adhesive may be used, including cyanoacrylate-based adhesives, polyvinyl alcohol (PVA) adhesives, polyvinyl acetate adhesives, multipurpose spray adhesives, hot melt glues, and more. EPS-based molded articles cannot be joined using typical glues because the solvents present in these glues damage the surface of the EPS and prevent adhesion. By forming the custom product packaging using molded bead foam articles formed from PLA, it was unexpectedly discovered that most common glues may be used to adhere two pieces of PLA bead foam articles. Molded foam articles may therefore first be machined as described herein to produce one or more smaller molded foam articles, and these smaller molded foam articles may be glued together to produce the custom product packaging, thereby extending the life of the molded foam without waste or even recycling or compost.

In some embodiments, the custom product packaging includes at least two molded bead foam articles adhering together without any adhesive. It has been unexpectedly discovered that by cutting a surface of the molded bead foam article to create a “fresh” surface, a first molded bead foam article can be joined with another “fresh” surface on a second molded bead foam article. The joining of these molded bead foam articles produces a bond strength comparable to an uncut molded foam article. This enables the formation of custom product packaging that is formed from the joining of two or more molded bead foam articles. In contrast, no such adhesion potential is possible with EPS-based molded articles.

In some embodiments, custom product packaging includes at least two molded bead foam articles adhered together by heated at least one surface of a first molded bead foam article using a heating element and pressing the at least one surface against a second molded bead foam article. It has been unexpectedly discovered that heating the surface of the molded bead foam article formed from PLA-based beads can be performed without producing flammable gas. The heating element may be a clothing iron, a heat gun, heated-platen press having a temperature of between about 85° C. to about 175° C. (depending on the duration of the platen press contact), low-pressure or saturated steam, or water having a temperature of between about 85° C. to about 110, such as between about 92° C. to about 98° C. When heating with water having a temperature of between about 85° C. to about 110° C., only between about 3 seconds to about 10 seconds of exposure is needed to sufficiently heat the surface of the PLA-based molded bead foam article. By using a heating element, such as a clothing iron, only the desired surface of the molded bead foam article is heated. In other embodiments, heating with a heated-platen press at 175° C. for a short period of time, on the order of 2-3 seconds, allowed the surface to reach similar adhesion properties. It has been unexpectedly discovered that a heated surface of a molded bead foam article may be joined with another molded bead foam article, or two heated surfaces of two molded foam articles formed from PLA may be joined and bonded with a strength comparable to a single molded foam article. Similar bonding has not proven possible with EPS, EPP, or EPE with household appliances such as hair dryer and clothes iron. Instead, hot air welding is necessary to join articles formed from EPP and EPE, which is a process operating at higher temperatures than those achievable with household appliances, necessitating the use of special controls and guards on hot air welding machines. Without intending to be bound by any particular theory, it is believed that PLA-based articles have a glass transition temperature (T_{g}), melting temperature (Tₘ), and degree of crystallinity that is favorable for producing the necessary tackiness upon heating at temperatures achievable with household appliances, steam, or hot water.

In some embodiments, one of the at least two molded bead foam articles that is adhered to the other molded bead foam article is an auxiliary piece of molded bead foam that is adhered to the inside of the product packaging to further customize the internal size and shape of the product packaging. For example, a product packaging formed from one or more molded bead foam articles having a cavity for a product may have a cavity with a rectangular-prism shape. An auxiliary piece of molded bead foam may be adhered to the interior surface of this cavity to accommodate products having irregular shapes, to accommodate multiple products simultaneously, or the like.

In some embodiments, the at least one molded bead foam article is manipulable from a first shape to a second shape by thermoforming, wherein the thermoforming involves contacting the at least one molded bead foam article with a heating element, such as water having a temperature of between about 85° C. to about 110° C. for between about 1 seconds to about 30 seconds, depending on the thickness of the at least one molded bead foam article and the desired end-shape. In some embodiments, the thermoforming may involve contacting the at least one molded bead foam article with a heating element such as a heated-platen press to a temperature of between about 85° C. to about 175° C., which may advantageously enable uniform heating of an entire surface of the molded bead foam article. In some embodiments, the thermoforming may involve contacting the at least one molded bead foam article with a heating element that such as a clothing iron, a heat gun, or low-pressure or saturated steam. For example, it has been unexpectedly discovered that PLA-based molded bead foam articles having a thickness of about 1 inch that have been heated by water having a temperature of between about 85° C. to about 110° C., such as between about 92° C. to about 102° C., for between about 8 seconds to about 30 seconds may be shaped by hand, such as by wrapping the molded bead foam article around a cylinder to produce a substantially cylindrical molded foam article. This may enable the production of custom-shaped molded foam articles without the need for expensive custom molds, which further enables the formation of the custom product packaging. The thermoforming process requires only about 20 seconds of holding the water-heated molded bead foam article in a particular position or shape to induce the molded bead foam article to retain the shape. Therefore, by combining the predefined guides, machining, and/or thermoforming, highly customizable product packaging may be formed from one or more PLA-based molded bead foam articles, even if the molded bead foam articles vary in their initial shapes and intended purposes.

In some embodiments, the at least one molded bead foam article has a compressive resistance and density that have been enhanced by a boiling process, such as boiling a molded bead foam article having a thickness of about 1 inch for between about 1 minute to about 3 minutes. It has been unexpectedly discovered that boiling a PLA-based molded bead foam article for between about 1 minute to about 3 minutes results in partial collapse of the PLA foam beads that form the molded bead foam article. The result is an increase in density and an increase in compressive resistance. The density may be increased by about 8% after about 20 seconds of boiling, or by about 25% after 60 seconds of boiling. The compressive resistance, as measured by ASTM D3575, decreases compared to the compressive resistance of the molded bead foam article before boiling. Boiling the molded bead foam article to enhance mechanical properties can be combined with the predefined guides, machining, and thermoforming disclosed herein to produce custom product packaging having improved compressive resistance, dramatically widening the use-cases for the custom product packaging. It has been unexpectedly discovered that boiling the PLA-based foam article results in mechanical properties comparable to expandable polypropylene (EPP), but with a material that is biobased and biodegradable.

In some embodiments, the at least one molded bead foam article is configured as a kit or part of a kit designed to be machined, adhered or thermoformed into the custom protective packaging. For example, the at least one molded bead foam article may include predefined guides that, when machined along those predefined guides, produce a plurality of smaller bead foam articles designed to be combined in a specific way, i.e., as a kit.

In some embodiments, the at least one molded bead foam article is an existing molded bead foam article having an initial intended use, such as an insulative piece of PLA-based bead foam included in a product packaging to product a product. In some embodiments, the existing piece of PLA-based bead foam was originally used as thermal protection for temperature-sensitive products, as impact protection for fragile products, or a combination thereof. Rather than discarding this PLA-based bead foam article, it may be used as described herein by modifying it through at least one of (i) machining, (ii) adhesion to another molded bead foam article, (iii) boiling, or (iv) thermoforming to form at least a portion of a customized product packaging.

Methods for Producing Custom Product Packaging

Methods for producing custom product packaging are also disclosed herein. In one aspect, the methods include producing custom product packaging as described above. In another aspect, the method includes molding a plurality of foam beads including polylactic acid to produce at least one molded bead foam article, and subjecting the at least one molded bead foam article to at least one secondary process to form the custom product packaging. In some embodiments, the secondary process comprises (i) machining, (ii) adhesion to another molded bead foam article, (iii) boiling, or (iv) thermoforming.

In some embodiments, the at least one secondary process includes machining the at least one molded foam article, wherein machining the at least one molded bead foam article produces less dust relative to a comparable molded bead foam article formed from expandable polystyrene. In some embodiments, the molding process includes providing predefined guides on the at least one molded bead foam article for guiding the machining of the at least one molded bead foam article. In some embodiments, the predefined guides are a predefined distance apart. In some embodiments, the method includes producing one or more molded foam panels using the predefined guides when the at least one molded bead foam article is machined along the predefined guides.

In some embodiments, the method includes producing at least two molded bead foam articles and adhering a first molded bead foam article to a second molded bead foam article using an adhesive. In some embodiments, the adhesive is selected from (i) cyanoacrylate, (ii) polyvinyl acetate, or (iii) a hot melt adhesive. Any common adhesive may be used because PLA bead foam articles are capable of adhesion using adhesives. In contrast, expandable polystyrene is not capable of adhesion using most common household glues.

In some embodiments, the method includes producing at least two molded bead foam articles, heating a surface of a first molded bead foam article using a heating element, heating a surface of a second molded bead foam article with the heating element, and adhering the first molded bead foam article to the second molded bead foam article by pressing the heated surfaces together. In some embodiments, heating the molded bead foam article using a heating element does not produce flammable gas. In contrast, expandable polystyrene is produced using pentane as a blowing agent, which is a flammable gas; heating EPS-based molded articles carries the risk of igniting residual pentane. In some embodiments, the heating element is a clothing iron, a heat gun, a heated-platen press having a temperature of between about 85° C. to about 175° C. (depending on the duration of the platen press contact), or water having a temperature of 85° C. to 110° C. In some embodiments, the heating element is water having a temperature of 92° C. to 102° C. and the water is applied for 3-10 seconds.

In some embodiments, the method includes heating the at least one molded bead foam article using water having a temperature of 85° C. to 110° C. for 8-30 seconds, and thermoforming the heated molded bead foam article from a first shape to a second shape. In some embodiments, the method includes heating the at least one molded bead foam article using a heated-platen press having a temperature of between about 85° C. to about 175° C. for 0.25-8 seconds, and thermoforming the heated molded bead foam article from a first shape to a second shape. In some embodiments, the method includes heating the at least one molded bead foam article using a heating element that includes a clothing iron, a heat gun, or low-pressure or saturated steam, and thermoforming the heated molded bead foam article from a first shape to a second shape.

In some embodiments, the method includes boiling the at least one molded foam article, wherein the boiling process decreases compressive resistance, improves impact properties and increases density of the molded foam article. Boiling for as little as 8 seconds results in a noticeable change in the properties of the molded bead foam article, and these properties show particularly desirable improvement after around 1 minute of boiling. In some embodiments, the boiling process includes boiling the molded bead foam article for 1-3 minutes.

In some embodiments, the method includes adhering a material layer to a surface of the molded foam article. In some embodiments, the material layer is leather, vinyl, or fabric. In some embodiments, the material layer is adhered to the surface of the molded bead foam article using a heating element and, optionally, a hot melt adhesive sheet disposed between the surface of the molded bead foam article and the material layer. It has been unexpectedly discovered that many fabrics show satisfactory adhesion without the need for an additional adhesive sheet.

In some embodiments, the method is effective to produce a molded article having a shape suitable as at least partial protective packaging for an irregularly shaped commodity. For example, the method may be effective to produce a molded article suitable for protecting art, ceramics, and other fragile goods that may require critical dimensions incapable of being produced without a machining process. By utilizing the post-processing techniques described herein, it has been unexpectedly discovered that highly custom and uniquely shaped molded articles may be produced that are suitable for virtually any commodity, including commodities produced in very small quantities, such as original paintings.

Methods for Producing Protective Packaging

Methods for producing protective packaging are also disclosed herein. In one aspect, the methods include producing a molded bead foam article as described above. In another aspect, the method includes molding a plurality of foam beads including polylactic acid to produce at least one molded foam article. In some embodiments, the methods include shaping the at least one molded bead foam article into a shape, wherein the shape corresponds to at least a portion of an object. In some embodiments, the methods include combining one or more shaped foam articles into the protective packaging. By shaping a molded foam article into a shape that corresponds to at least a portion of an object, it may be used as protective packaging that is uniquely formed specifically for that object. In some embodiments, the object is a piece of art, a ceramic object, a musical instrument, an electronic device, a fragile object, or another object that may be particularly fragile, valuable, and/or having a unique shape.

In some embodiments, the shaping includes heating the molded foam article using a heat source and thermoforming the heated molded foam article into a shape. In some embodiments, the heat source includes a clothing iron, a heat gun, heated-platen press having a temperature of between about 85° C. to about 175° C., low-pressure steam, saturated steam, water having a temperature of between about 85° to about 110° C., or a combination thereof.

In some embodiments, the combining of the one or more shaped foam articles includes heating a first surface of one of the one or more shaped foam articles with a heating element, heating a second surface of one of the one or more shaped foam articles with a heating element, and then pressing the first and second surface together. In some embodiments, combining the one or more shaped foam articles comprising the application of glue or another adhesive.

### EXAMPLES

The disclosure may be further understood with reference to the following non-limiting examples.

### Example 1: Gluing PLA Bead Foam Articles

PLA bead foam articles were cut with a hot knife. Five glues were tested: Loctite® Instant Adhesive 454™ QuickTite®, available commercially from Uline, Pleasant Prairie, Wisonsin, USA; Titebond® Quick & Thick Multi-Surface Glue, available commercially from Franklin International Inc., Columbus, Ohio, USA; Elmer's® Glue, available commercially from Newell Office Brands, Atlanta, Georgia, USA; Gorilla Glue®, available commercially from Gorilla Glue Company, Cincinnati, Ohio, USA and Super 77™ Multipurpose Spray Adhesive, available commercially from 3M™, St. Paul, Minnesota, USA. Each tested glue was applied liberally to both cut surfaces, the surfaces were rejoined, and the panel was allowed to dry overnight. After drying, each panel was subject to a laterally divergent force so as to induce breakage. The results of the test are displayed in Table 1.

TABLE 1
Results of Gluing PLA-based Panels

| Adhesive | | |
|---|---|---|
| Brand | Adhesive Type | Results |
| Super Glue ® | Cyanoacrylate | PLA breakage, glued joint intact |
| Titebond ® | Polyvinyl alcohol (PVA) | PLA breakage, glued joint intact |
| | and other additives | |
| Elmers Glue ® | Polyvinyl alcohol (PVA) | PLA breakage, glued joint intact |
| Gorilla Glue ® | Polyurethane | PLA breakage, glued joint intact |
| 3M ™ Super | Petroleum based | PLA breakage, glued joint intact |
| 77 TM | multisubstrate spray | |
| | adhesive | |

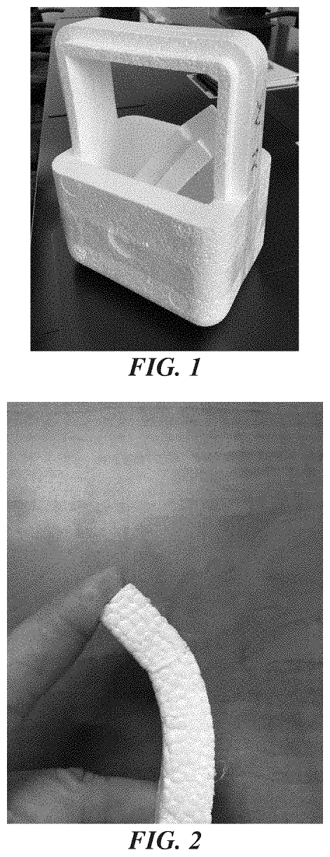

In each test, the PLA-based article failed at a location other than the glued joint. In contrast, EPS-based molded articles do not experience any adhesion using glue other than hot melt glue having a melting point below 95° C. By forming the molded articles from PLA, a wider variety of glues are available to consumers for gluing the molded articles and numerous secondary articles may be constructed, such as the basket depicted in FIG. 1.

### Example 2: Rejoining Cut PLA Bead Foam Article with Residual Heat

A molded article was formed from PLA as described herein. Immediately after molding, the molded article was cut into two pieces using a micro wire cutter, available at most craft stores. The fresh surfaces generated by the cut were rejoined. The joint was surprisingly robust and able to withstand bending pressure, as depicted in FIG. 2.

### Example 3: Joining Cut PLA Bead Foam Articles by Applying Heat

Two molded articles formed from PLA were molded as described herein. One surface of each molded bead foam article was heated with a clothing iron set at a temperature for “Linen, Cotton or Wool.” These heated surfaces were joined and allowed to cool. The flexural strength, deflection, and elasticity were measured in accordance with ASTM C203. The results are displayed in Table 2.

TABLE 2
Mechanical properties of molded foam
articles joined by heating with clothing iron

| | Solid PLA bead | Two PLA bead foam articles |
|---|---|---|
| | foam article | joined with clothing iron |
| Flexural | 24 | 18 |
| Strength (psi) | | |
| Deflection (in.) | 0.75 | 0.91 |
| Elasticity (psi) | 262 | 162 |

Although the two joined molded articles exhibited poorer flexural strength and elasticity, it was unexpectedly discovered that the deflection was nearly the same. By taking steps to normalize the process, such as a more sophisticated heating element and/or preparing the joined surfaces to have complementary shapes, an even stronger bond is expected.

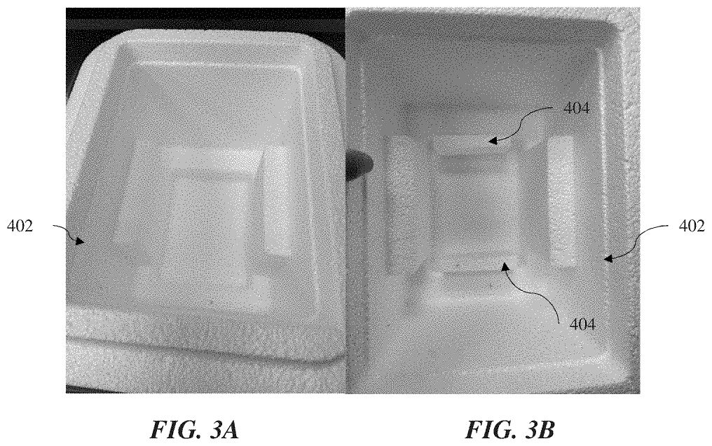

The adhesion of two molded articles may also be used to incorporate precise features within a larger molded article, as depicted in FIGS. 3A and 3B. FIG. 3A depicts a molded bead foam article 402 in the form of a box prior to the incorporation of additional molded articles. FIG. 3B depicts the inclusion of spacers 404, also known as undercuts, that have been adhered to article 402 through application of heat as described herein. Any number of spacers or other molded articles may be incorporated in this manner. This permits incorporation of features which would have not be possible to mold such as features outside of the limits of a suitable draft angle. For example, a feature parallel to the base of a container that is wider than the base itself. By incorporating a feature such as that shown in FIG. 3B, cooling components such as ice packs can be spaced away from the biological payload to ensure the contents stay at a suitable temperature.

### Example 4: Joining Cut PLA Bead Foam Articles by Applying Hot Water/Steam

Two molded articles formed from PLA were molded as described herein. One molded bead foam article was heated water at 92-98° C. for 3-10 seconds and pressed against the other molded foam article, at room temperature, then allowed to cool. The flexural strength, deflection, and elasticity were measured in accordance with ASTM C203. The results are displayed in Table 3.

TABLE 3
Mechanical properties of molded foam
articles joined by heating with hot water

| | Solid PLA bead | Two PLA bead foam articles |
|---|---|---|
| | foam article | joined with heated water |
| Flexural Strength | 24 | 8 |
| (psi) | | |
| Deflection (in.) | 0.75 | 0.9 |
| Elasticity (psi) | 262 | 72 |

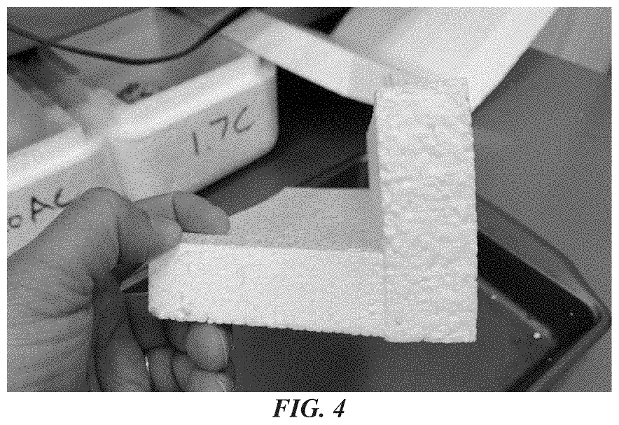

Although the two joined molded articles exhibited poorer flexural strength and elasticity, it was unexpectedly discovered that the deflection was nearly the same. An example joint formed by heating a PLA bead foam article by hot water is depicted in FIG. 4.

### Example 5: Thermoforming PLA Bead Foam Articles with Hot Water

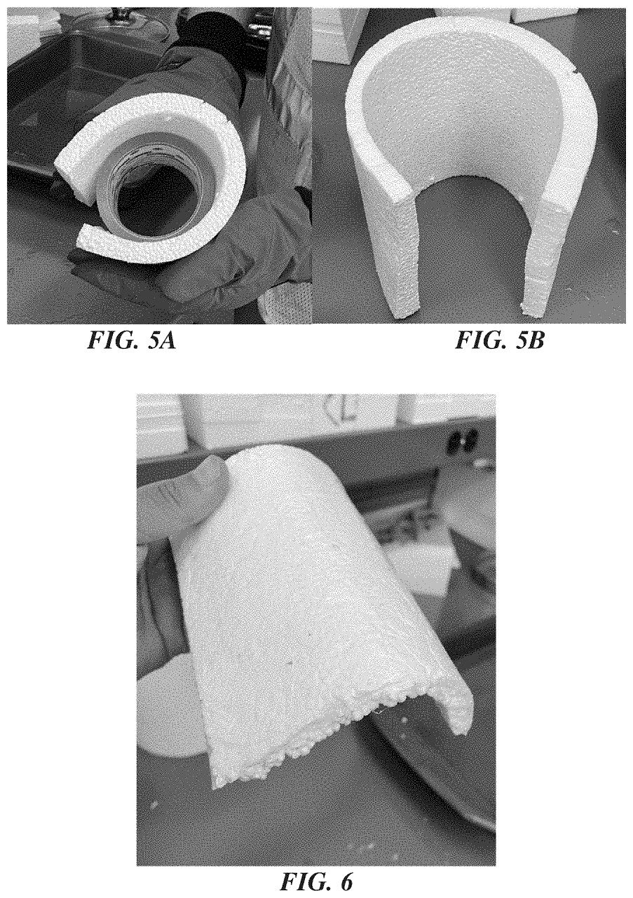

A molded article was formed from PLA as described herein and submerged in water at a temperature of approximately 92-98° C. for 8-30 seconds. Upon removal from the water, the article is deformable by hand. The article was wrapped around a cylinder and allowed to cool for about 20 seconds, as depicted in FIG. 5A. Upon removal from the cylinder, the article maintained the cylindrical shape, as depicted in FIG. 5B. In another test, the molded article was thermoformed around a 90° shape, forming an edge-protector as depicted in FIG. 6. Thus, it has been unexpectedly discovered that by forming the molded article from PLA, the molded article may be thermoformable by placing in a bath of hot water. This thermoforming process may be used to create custom insulation without the need for individual molds, reducing manufacturing time and costs.

### Example 6: Improvement of Mechanical Properties of PLA Bead Foam Article by Boiling

A molded article was formed from PLA as described herein and placed in boiling water for 1-3 minutes. The resulting mechanical properties were compared to expandable polypropylene and expandable polyethylene and are displayed in Table 4.

TABLE 4
Mechanical properties of molded foam
articles joined by heating with hot water

| | Compressive | Compressive | Density |
|---|---|---|---|
| | Resist (25%) psi | Set (25%) | (pcf) |
| PLA (1.2 pcf)— | 34 | 10% | 1.2 |
| Unboiled | | | |
| PLA (1.2 pcf)— | 31 | 6% | 1.3 |
| Boil 20 sec | | | |
| PLA (1.2 pct)— | 20 | 2% | 1.5 |
| Boil 60 sec | | | |
| EPP (1.2 pcf) | 15 | 14% | 1.2 |
| EPP (1.8 pcf) | 23 | 12% | 1.8 |
| EPP (2.8 pcf) | 42 | 7% | 2.8 |
| EPP (3.7 pcf) | 57 | 7% | 3.7 |
| EPE (1.3 pcf) | 10 | 3% | 1.3 |
| EPE (1.9 pcf) | 12 | 4% | 1.9 |

The compressive resistance was measured according to ASTM D3575 with 25% compression of the foam article. The molded article shrank slightly, as evidenced by an increase in density. The remaining properties compare favorably with EPP, which is a material carrying material costs of 3-5 times that of PLA. The PLA-based article that was boiled for 60 seconds had an unexpectedly low compressive set of 2%, meaning that the article recovers 98% of its original shape after 25% compression. Boiling the sample for 60 seconds decreased the stiffness (i.e., increased flexibility) while improving the compressive set. Furthermore, the boiled PLA article had a comparable stiffness to EPP at 1.8 pcf density.

Thus, it has been unexpectedly discovered that boiling PLA bead foam articles can produce a dense molded foam comparable to EPP at significantly lower costs, allowing the boiled PLA to be used in applications such as furniture. The duration of the boiling process affects the resulting mechanical properties, allowing for the tuning of the resulting properties as desired for the given application. Further still, combining the enhancement of mechanical properties with hot water thermoforming provides for even greater cost reductions in the formation of uniquely shaped articles having properties comparable to EPP.

### Example 7: Combination of Post-Processing Methods

Various post-processing methods as described herein were performed on molded articles and the mechanical properties of the resulting articles as measured by ASTM C203 were compared. The results are displayed in Table 5.

TABLE 5
Comparison of mechanical properties for
combinations of post-processing techniques

| | Flexural | Deflection | Elasticity | Density |
|---|---|---|---|---|
| | Strength (psi) | (in.) | (psi) | (pcf) |
| PLA Bead | 10 | 0.9 | 72 | 1.2 |
| Foam: Steam- | | | | |
| Weld | | | | |
| PLA Bead | 16 | 0.65 | 196 | 1.2 |
| Foam: 60 sec | | | | |
| Boil | | | | |
| PLA Bead | 16 | 2 | 64 | 1.5 |
| Foam: 60 sec | | | | |
| Boil with Tape | | | | |
| Lamination | | | | |
| PLA Bead | 18 | 0.91 | 162 | 1.2 |
| Foam joining | | | | |
| with Iron | | | | |
| PLA Bead | 19 | 0.72 | 217 | 1.2 |
| Foam: 20 sec | | | | |
| Boil | | | | |
| PLA Bead | 26 | 0.75 | 262 | 1.2 |
| Foam Plank | | | | |
| EPP Plank | 11 | 2 | 43 | 1.2 |
| EPS Plank | 34 | 0.69 | 300 | 1.25 |

As demonstrated by Table 5, the mechanical properties of a given PLA bead foam article may be tuned through the selection of several post-processing techniques and the parameters of those techniques.

### Example 8: Use of Heated-Platen Press for Thermoforming and Adhesion

A test was conducted using a commercially available heated-platen press to heat the surface of a molded article of PLA and adhere it to another PLA-based molded bead foam article. The heat press used in this experiment was a 12″×9″ Cricut® EasyPress™ 2 with PTFE Teflon Tape (High-Temp Fiberglass Adhesive Tape) applied over the heated platen's surface. A 1.5″×3″ wide block of PLA-based molded bead foam was pressed against the heated platen having a temperature setpoint of 150° C. After pressing against the platen with less than 5 pound-force, the PLA-based molded bead foam was removed and immediately pressed against another 1.5×3″ wide block of PLA resulting in a single piece which was 1.5″×3″×8″. This block was subsequently tested for flexural strength, deflection, and elasticity in accordance with ASTM C203. This test was repeated again with a 1.5″×3″ wide block of PLA foam being pressed against the platen when heated to 163° C. and 175° C. The results are shown in Table 6, below:

TABLE 6
Mechanical Properties of Articles joined by
Heating with Heated-Platen Press

| | PLA Heat | PLA Heat | PLA Heat |
|---|---|---|---|
| | Press at | Press at | Press at |
| | 150° C. | 163° C. | 175° C. |
| Flexural Strength (psi) | 32 | 29 | 26 |
| Deflection (in.) | 0.73 | 0.76 | 0.89 |
| Elasticity (psi) | 312 | 274 | 207 |

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

That which is claimed is:

1. A custom product packaging comprising at least one molded bead foam article comprising polylactic acid, wherein the at least one molded bead foam article has been modified through at least one of (i) machining, (ii) adhesion to another molded bead foam article, (iii) boiling, or (iv) thermoforming.

2. The custom product packaging of claim 1 wherein, when the at least one molded bead foam article is at least partially machined.

3. The custom product packaging of claim 2, wherein machining the molded bead foam article produces less dust than a comparable molded bead foam article formed from expandable polystyrene.

4. The custom product packaging of claim 1, wherein the at least one molded bead foam article comprises predefined guides for (i) guiding machining of the at least one molded bead foam article, (ii) guiding adhering the at least one molded bead foam article to another molded bead foam article, or (iii) both.

5. The custom product packaging of claim 4, wherein the predefined guides are spaced a predefined distance apart.

6. The custom product packaging of claim 4, wherein the predefined guides are defined such that, when the molded bead foam article is machined along the predefined guides, one or more molded foam panels are produced corresponding to the custom product packaging.

7. The custom product packaging of claim 1, wherein the custom product packaging comprises at least two molded bead foam articles adhered together using an adhesive.

8. The custom product packaging of claim 7, wherein the adhesive is selected from (i) cyanoacrylate, (ii) polyvinyl acetate, or (iii) a hot melt adhesive.

9. The custom product packaging of claim 1 wherein the custom product packaging comprises at least two molded bead foam articles adhered together by heating at least one surface of a first molded bead foam article using a heating element and pressing the at least one surface against a second molded bead foam article.

10. The custom product packaging of claim 9, wherein heating the at least one surface of the first molded bead foam article is performed without producing flammable gas.

11. The custom product packaging of claim 9, wherein the heating element comprises a clothing iron, a heat gun, a heated-platen press having a temperature of 85° C. to 175° C., saturated steam, or water having a temperature of 85° C. to 110° C.

12. The custom product packaging of claim 9, wherein the heating element comprises water having a temperature of 85° C. to 110° C., and the water is applied for 3-10 seconds.

13. The custom product packaging of claim 1, wherein the at least one molded bead foam article is manipulable from a first shape to a second shape by thermoforming, wherein the thermoforming comprises (i) contacting the at least one molded bead foam article using water having a temperature of 85° C. to 110° C. for 8-30 seconds, (ii) contacting the at least one molded bead foam article using a heated-platen press having a temperature of 85° C. to 175° C., or (iii) contacting the at least one molded bead foam article with a heating element that includes at least one of a clothing iron, a heat gun, or low-pressure or saturated steam.

14. The custom product packaging of claim 1, wherein the at least one molded bead foam article has a compressive resistance and density that have been enhanced by a boiling process.

15. The custom product packaging of claim 14, wherein the boiling process comprises boiling the at least one molded bead foam article for 0.25-3 minutes.

16. The custom product packaging of claim 1, wherein the at least one molded bead foam article is configured as a kit or a part of a kit designed to be thermoformed into the customized protective packaging.

17. A method for producing custom product packaging comprising:
molding a plurality of foam beads comprising polylactic acid to produce at least one molded foam article, and
subjecting the at least one molded bead foam article to at least one secondary process to form the custom product packaging, wherein the secondary process comprises (i) machining, (ii) adhesion to another molded bead foam article, (iii) boiling, or (iv) thermoforming.

18. The method of claim 17, wherein the at least one secondary process comprises machining the at least one molded foam article, wherein machining the at least one molded bead foam article produces less dust relative to a comparable molded bead foam article formed from expandable polystyrene.

19. The method of claim 17, wherein the molding process further comprises providing predefined guides on the at least one molded bead foam article for (i) guiding machining of the at least one molded bead foam article, (ii) guiding adhering the at least one molded bead foam article to another molded bead foam article, or (iii) both.

20. The method of claim 19, wherein the predefined guides are spaced a predefined distance apart.

21. The method of claim 19, further comprising machining the at least one molded bead foam article along the predefined guides to produce one or more molded bead foam panels.

22. The method of claim 17, wherein molding the plurality of foam beads produces at least two molded foam articles, and wherein the method further comprises:
adhering a first molded bead foam article to a second molded bead foam article using an adhesive.

23. The method of claim 22, wherein the adhesive is selected from (i) cyanoacrylate, (ii) polyvinyl acetate, or (iii) a hot melt adhesive.

24. The method of claim 17, wherein molding the plurality of foam beads produces at least two molded foam articles, and wherein the method further comprises:
heating a surface of a first molded bead foam article with a heating element,
heating a surface of a second molded bead foam article with the heating element, and
adhering the first molded bead foam article to the second molded bead foam article by pressing the heated surfaces together.

25. The method of claim 24, wherein the heating element comprises a clothing iron, a heat gun, a heated-platen press having a temperature of 85° to 175° C., low-pressure steam, saturated steam, or water having a temperature of 85° C. to 110° C.

26. The method of claim 24, wherein the heating element comprises water having a temperature of 85° C. to 110° C., and wherein the water is applied for 3-10 seconds.

27. The method of claim 17, further comprising:
heating the at least one molded bead foam article using water having a temperature of 85° C. to 110° C. for 8-30 seconds, and
thermoforming the at least one heated molded bead foam article from a first shape to a second shape.

28. The method of claim 17, further comprising boiling the at least one molded bead foam article,
wherein boiling the at least one molded bead foam article enhances a compressive resistance and a density of the at least one molded foam article.

29. The method of claim 28, wherein the boiling process comprises boiling the molded bead foam article for 0.25-3 minutes.

30. A method of producing protective packaging, the method comprising:
molding a plurality of foam beads comprising polylactic acid to produce at least one molded bead foam article,
shaping the at least one molded bead foam article into a shape, wherein the shape corresponds to at least a portion of an object, and then
combining one or more shaped foam articles into the protective packaging.

31. The method of claim 30, wherein the object is a piece of art, a ceramic object, a musical instrument, an electronic device, a fragile object, or the like.

32. The method of claim 30, wherein the shaping comprises heating the molded bead foam article using a heat source and thermoforming the heated molded foam article into the shape.

33. The method of claim 32, wherein the heat source comprises a clothing iron, a heat gun, a heated-platen press having a temperature of 85° C. to 175° C., low-pressure steam, saturated steam, water having a temperature of between about 85° C. to about 110° C., or a combination thereof.

34. The method of claim 30, wherein the combining of the one or more shaped foam articles comprises:
heating a first surface of one of the one or more shaped foam articles with a heating element,
heating a second surface of one of the one or more shaped foam articles with a heating element, and then
pressing the first surface and the second surface together.

35. The method of claim 30, wherein the combining of the one or more shaped foam articles comprises:
heating at least one surface of one of the one or more shaped foam articles with a heating element, and then
adhering the heated surface to another of the one or more shaped foam articles.

36. The method of claim 30, wherein the combining of the one or more shaped foam articles comprises the application of glue or another adhesive.
